(19) United States
(12) Patent Application Publication
(10) Pub. No.: US 2013/0022769 A1
(43) Pub. Date: Jan. 24, 2013

(54) INSULATING MATERIAL COMPRISING AN ELASTOMER IMPREGNATED WITH AEROGEL-BASE

(71) Applicants: Firouzeh Sabri, Lakeland, TN (US); Jeffrey Marchetta, Memphis, TN (US)

(72) Inventors: Firouzeh Sabri, Lakeland, TN (US); Jeffrey Marchetta, Memphis, TN (US)

(73) Assignee: University of Memphis Research Foundation, Memphis, TN (US)

(21) Appl. No.: 13/399,892

(22) Filed: Feb. 17, 2012

Related U.S. Application Data
(60) Provisional application No. 61/444,472, filed on Feb. 18, 2011.
(60) Provisional application No. 61/447,690, filed on Feb. 28, 2011.

(51) Int. Cl. F16L 59/00; B32B 1/08; B32B 1/02; E04B 1/78; B32B 5/18

(52) U.S. Cl. 428/36.5; 252/62; 427/372.2; 428/304.4; 428/319.1; 428/319.3; 428/36.9; 428/221

(57) ABSTRACT

This invention relates to an lightweight, flexible, elastomeric, clear or opaque, optionally pigmented, pliable insulating material comprising an aerogel base material and a polymer material. The aerogel may be silica aerogel, a carbon aerogel, an alumina aerogel, a chalcogel, or an organic aerogel and may be crosslinked with polyurea or vanadium. In certain embodiments the aerogel is embedded within the silicone base polymer. In other embodiments the insulating material is composed of layers of aerogel impregnated polymer such that each layer comprises a different amount of aerogel, a different stiffness, a different thermal conduction behavior, or any other desirable parameter. Such layers can be assembled utilizing, for example, but without limitation, an onion layer approach. The layers of aerogel impregnated polymer may be color coded for identification of insulating properties.

### CROSS REFERENCE TO RELATED APPLICATIONS

This application claims the benefit of priority to U.S. Provisional Patent Application No. 61/444,472, filed Feb. 18, 2011 and U.S. Provisional Patent Application No. 61/447,690, filed Feb. 28, 2011 the disclosures of each of which are expressly incorporated herein by reference in their entireties.

### FIELD OF THE INVENTION

This invention relates to an lightweight, flexible, elastomeric, clear or opaque, optionally pigmented, pliable insulating material comprising an aerogel base material and a polymer material. The aerogel may be silica aerogel, a carbon aerogel, an alumina aerogel, a chalcogel, or an organic aerogel and may be crosslinked with polyurea or vanadium. In certain embodiments the aerogel is embedded within the silicone base polymer. In other embodiments the insulating material is composed of layers of aerogel impregnated polymer such that each layer comprises a different amount of aerogel, a different stiffness, a different thermal conduction behavior, or any other desirable parameter. Such layers can be assembled utilizing, for example, but without limitation, an onion layer approach. The layers of aerogel impregnated polymer may be color coded for identification of insulating properties.

### BACKGROUND OF THE INVENTION

Native and crosslinked aerogels have been considered for various space-related applications due to their light weight (99.9% air) and in some cases high mechanical strength compared to the native types of aerogels. Aerogels were invented in the 1930s and consist of a pearl-necklace-like network of skeletal nanoparticles, leaving more than 99% of their bulk volume empty. Chemically, the skeletal nanoparticles of most typical aerogels are made of silica. So far, the two major uses of aerogels have been as collectors of hypervelocity particles in space (Burchell 2009) upon NASA's Stardust Program and as thermal insulation of the electronic boxes on the Mars Rovers (Paul 2003).

Long duration space missions will require new, reliable technologies in managing and storing cryogenic propellants. Cryogenic propellant tanks in space, such as an orbiting propellant depot, and on planetary surfaces (e.g. Moon, Mars) are exposed to incident solar radiation causing an increase in pressure as the liquid vaporizes (self pressurization).

In the near term, cryogens are the likely candidate for any human lunar return or Mars exploration missions. As such, reliable technologies will be required to manage and store cryogenic propellants for long periods in space and on remote outposts. Due to the high costs associated with conducting experiments in space, the ability to assess the feasibility of these technologies relies on the development of a robust and accurate simulation of the tank-self pressurization process. Furthermore, lightweight thermal insulation is considered mission enabling technology for any future orbiting propellant depots or long duration missions where cryogens are used.

Apart from active systems, such as cryocoolers and jets, numerous passive insulation methods have been proposed for controlling the tank pressure for long duration space missions. The majority of proposed technologies are focused on insulating techniques for metal-based and/or composite cryogenic tanks. Exposure of these materials to cryogenic temperatures and repeated thermal cycling causes brittleness and development of microcracks. Therefore, they are unreliable for long term storage of cryogenic propellants.

Thermal insulation is also utilized in many locations in motor vehicles and jet propelled vehicles and jet engines for the purpose of controlling ambient temperature conditions and/or preventing thermal damage to temperature-sensitive components. Similarly insulation material is currently employed in other applications including appliances, tools, construction materials and consumer goods such as cups, windows, and home insulation.

Aerogel technology has become a rapidly developing area for thermal insulation applications [1,2]. The majority of insulation designs available today are based on beads (pellets) [3] of native (non crosslinked) silica aerogels packed into a “blanket” [4]. This “blanket” is then wrapped around the metallic or composite tank. Since native aerogels are very fragile, brittle, and inherently hydrophilic, the range of insulation design is severely limited. If the “aerogel blanket” is subject to pressure, the aerogel beads will crush and fragment further leading to uneven distribution of insulation. A serious drawback of any “blanket” technology is that to accomplish an acceptable level of thermal isolation multiple layers are required (30-60 layers for MLI) and each layer must be physically isolated from the next layer. Given that MLI is anisotropic by nature, it is difficult to apply to complex geometries. An additional weakness of native silica aerogels is that they are strongly hydrophilic. Contact with aqueous solutions can cause the structure to break down creating a major problem for sterilization of aerogel-based components. By crosslinking the silica chains with polyurea or vanadium [5,6], the mechanical properties of the native silica aerogels can be improved by several orders of magnitude. Additionally, by applying a hydrophobic coating to the silica building blocks the material can be made to withstand solvent based sterilization techniques.

Nevertheless, there remains a need to develop novel insulating materials which provide high thermal insulation while remaining chemically and electrically resistant, resilient, pliable, flexible, and elastic at temperatures below room temperature.

### BRIEF SUMMARY OF THE INVENTION

The present invention relates to an insulating material which provides advantages over traditional materials and metal based materials in that the aerogel based material described herein provides high thermal insulation while remaining chemically and electrically resistant, resilient, pliable and flexible against low temperatures, including, but not limited to temperature below room temperature.

In one aspect, the invention provides an insulating material comprising a polymer material and an aerogel base material. In another aspect, the invention provides an insulating material comprising one or more layers wherein each layer comprises a polymer material and an aerogel base material.

In certain embodiments the polymer material and the aerogel base material are compounded to form a single compound polymer-aerogel material.

In still other embodiments, the insulating material comprises a polymer material which is an elastomeric polymer. In some embodiments, the elastomeric polymer may be an unsaturated rubber, a saturated rubber, or a thermoplastic rubber. In still other embodiments, the elastomeric polymer may be cis-1,4-polyisoprene natural rubber, trans-NYC 1,4-polyisoprene gutta-percha, synthetic polyisoprene, polybutadiene, chloroprene rubber (cr), polychloroprene, neoprene, baypren, butyl rubber, halogenated butyl rubber, styrene-butadiene rubber, nitrile rubber, hydrogenated nitrile rubber, therban, zetpol, epm rubber, epdm rubber, epichlorohydrin rubber, polyacrylic rubber, silicone rubber, fluorosilicone rubber, a fluoroelastomer, a perfluoroelastomer, a polyether block amide, chlorosulfonated polyethylene, or ethylene-vinyl acetate. In yet other embodiments, the elastomeric polymer is a liquid silicone rubber. In specific embodiments the silicone rubber is RTV 655.

In another embodiment, the insulating material comprises an aerogel base material which is a silica aerogel, a carbon aerogel, an alumina aerogel, a chalcogel, or an organic or inorganic aerogel. In certain embodiments the aerogel base material is a silica aerogel.

In yet another embodiment, the insulating material comprises a polymer material and an aerogel base material wherein the polymer material is a silicone rubber and the aerogel base material is a silica aerogel.

In some embodiments of the insulating material of the invention, the aerogel base material is in the form of one or more discrete aerogel geometric bodies. In other embodiments, the aerogel base material is in the form of a plurality of discrete aerogel geometric bodies.

Such aerogel geometric bodies may be in the form of plates, discs, coins, beads, grains, rings, fibers, or microspheres. Such geometric bodies can be both of regular and irregular shapes and sizes or a combination thereof. In specific embodiments, the aerogel geometric bodies have a thickness from about 1 μM to about 5 cM. In other embodiments, the aerogel geometric bodies and the polymer material (i.e. the insulating material) have a total thickness from about 2 μM to about 10 cM.

In some embodiments the aerogel base material may be tinted or color coded. Such tinting or color coding may be done to indicate layer thickness, layer thermal properties, layer dielectric properties, layer stiffness, or any other desirable property or any combination thereof. In some embodiments of the insulating material of the invention, the porous base material is in the form of one or more discrete porous geometric bodies. In other embodiments, the porous base material is in the form of a plurality of discrete porous geometric bodies.

Still another aspect of the invention provides an insulating material comprising a polymer material and an porous base material. In another aspect, the invention provides an insulating material comprising one or more layers wherein each layer comprises a polymer material and a porous base material. In certain embodiments the polymer material and the porous base material are compounded to form a single compound polymer-aerogel material.

Another aspect of the invention provides a method for preparing an insulating material comprising a polymer material and an aerogel base material comprising

a. synthesizing an aerogel to form discrete aerogel geometric bodies; and

b. impregnating the polymer material prior to curing the polymer material with the aerogel geometric bodies; and

c. curing the polymer material to form the insulating material.

In some embodiments the method of preparing the insulating material further comprises the step of determining an optimized arrangement of aerogel geometric bodies within the material prior to step b. In still other embodiments, the step of optimizing the arrangement of aerogel geometic bodies comprises determining the size and shape of the aerogel geometric bodies; determining the distribution pattern of the aerogel geometric bodies; or both.

In other embodiments, the method of preparing the insulating material may be performed that step b. is performed after partial curing of the polymer material but prior to compete curing the polymer material. That is, the curing of the polymer material can occur in stages before, during and after impregnation with the aerogel geometric bodies.

Another aspect of the invention provides an article comprising an insulating material comprising a polymer material and an aerogel base material.

In one embodiment, the article of the invention comprises one or more layers of an insulating material comprising a polymer material and an aerogel base material.

In another embodiment, the article is fabricated directly from the insulating material.

In yet another embodiment, the article is fabricated by coating, layering, embedding, surrounding, encapsulating, or enrobing a pre-fabricated article with the insulating material. In certain embodiments, the pre-fabricated article is made of metal, plastic, silicone, polymer, elastomer, wood, glass, porcelain, bone, stone, ceramic, or concrete.

In some embodiments, the article of the invention is capable of withstanding high temperatures. In other embodiments, the article of the invention is capable of withstanding low temperatures.

In still other embodiments the article or the pre-fabricated article is a container for storing liquids or gases, including, but not limited to a tank, including a cyrogenic tank, a cup, a bowl, a cryostat, or a pot container. In other embodiments, the article or the pre-fabricated article is a tube for transporting liquids. In still other embodiments, the article or the pre-fabricated article is a window or window insulation, home insulation, or an insulated fabric.

### BRIEF DESCRIPTION OF THE DRAWINGS

FIG. 1 is a Schematic diagram showing clear silicone polymer sections impregnated/layered with aerogel components. In FIG. 1(c), the cylindrical shape of a dewar is recreated by sealing together procured wall components. The outer most layer can be sputter-coated with a reflective thin film for added thermal insulation.

FIG. 2 is a series of photographs showing a polymeric material without aerogel incorporation; an aerogel monolith; and an insulating material of the invention incorporating an aerogel monolith in a polymeric material.

FIG. 3 is a series of photographs showing insulating materials of the invention having various volume of aerogel to insulating material (VR=32%, VR=52% VR=57% and VR=62%).

FIG. 4 is a series of photographs showing two samples of the insulating material of the invention. In each photo the insulating material is an elastomeric polymer having aerogel geometric bodies impregnated therein.

FIG. 5 is a photographs showing three samples of the insulating material of the invention.

FIG. 6 shows the mechanical response to tensile stress of a polymeric material without aerogel.

FIG. 7 shows the mechanical response to tensile stress of the insulating material of the invention.

FIG. 8 shows the mechanical response to tensile stress for a polymeric material without aerogel compared to the insulating material of the invention.

FIG. 9 is a Schematic diagram showing the experimental setup used to determine fatigue using optical means.

FIG. 10 is a Schematic diagram showing the sample holder used to create controlled amounts of tension causing propagation of tears in the samples tested.

FIGS. 11, 12 and 13 are a series of photographs showing three samples of polymeric material subjected to the optical fatigue methods described herein.

FIGS. 14 and 15 show the effects of stretching polymeric materials in the optical fatigue methods described herein.

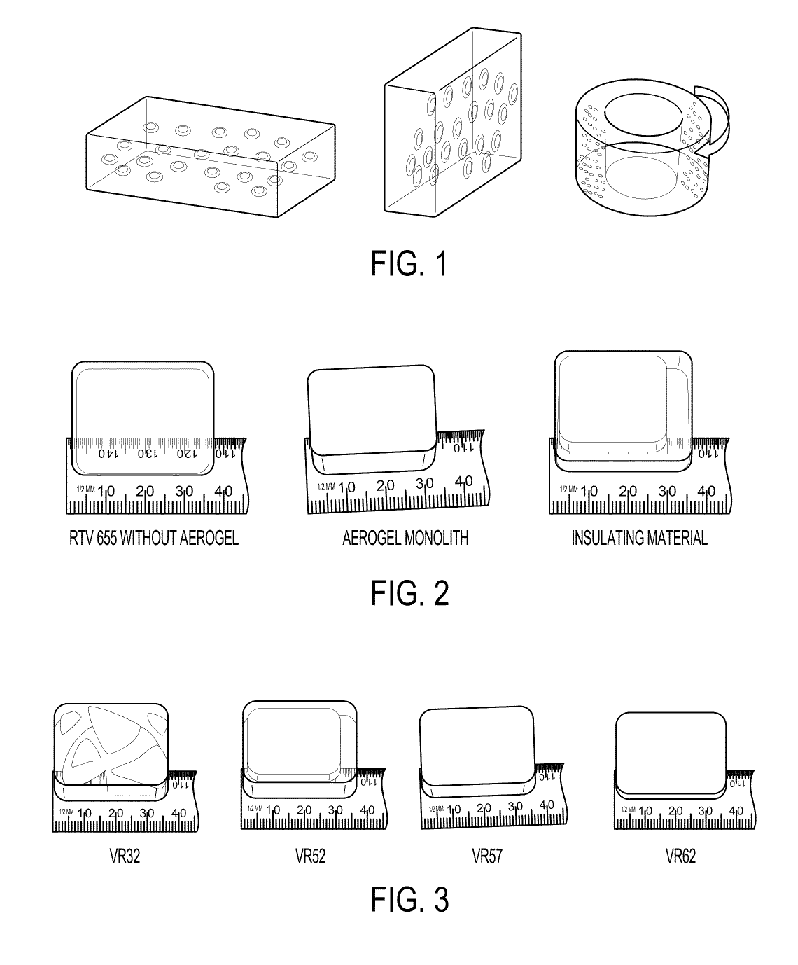

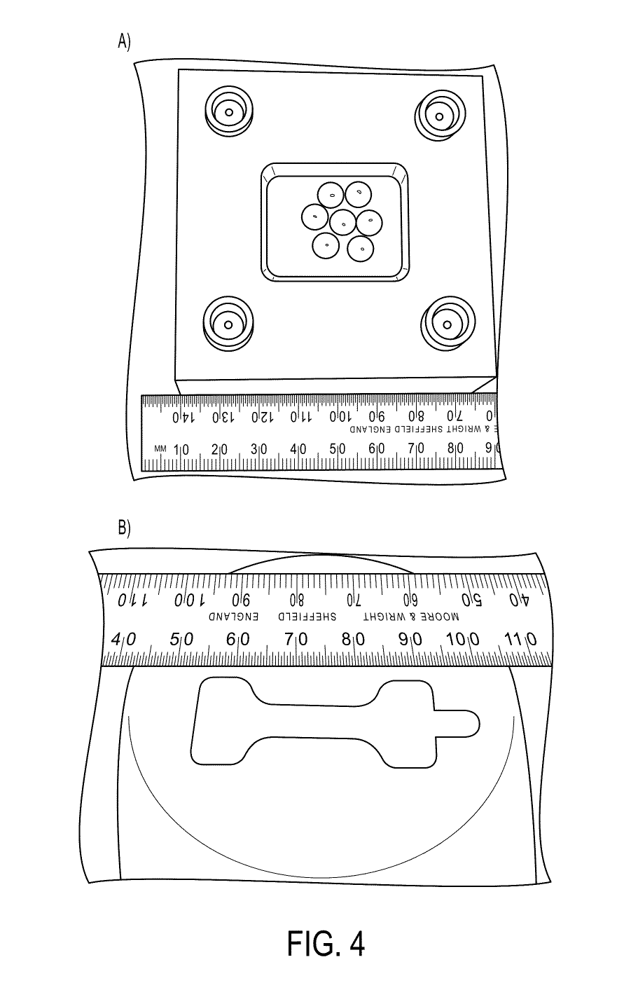

FIG. 9 is a Schematic diagram showing the experimental setup used to determine fatigue using optical means.

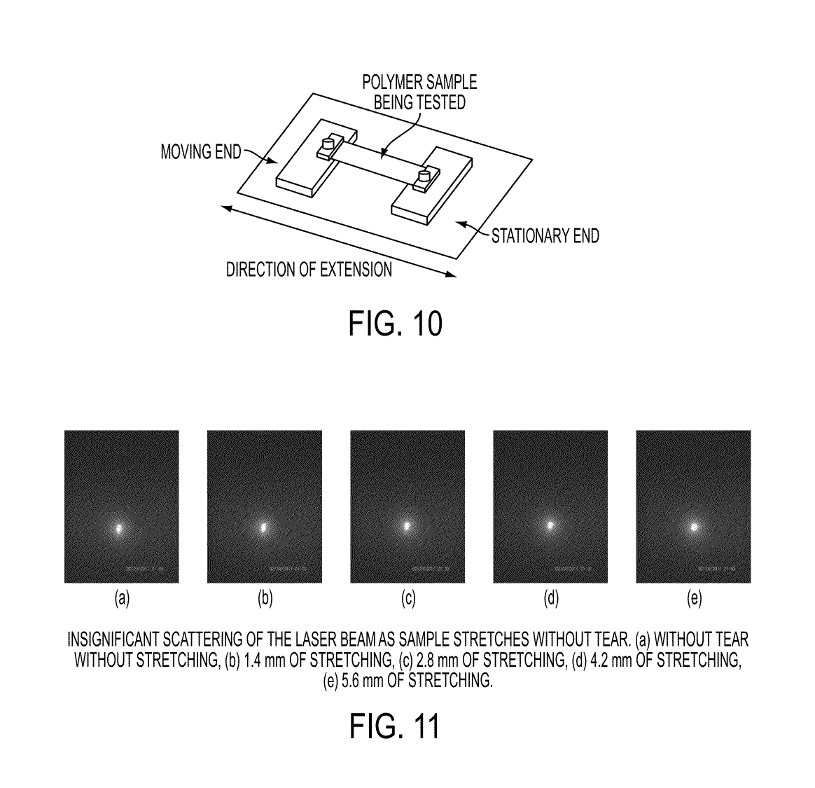

FIG. 10 is a Schematic diagram showing the sample holder used to create controlled amounts of tension causing propagation of tears in the samples tested.

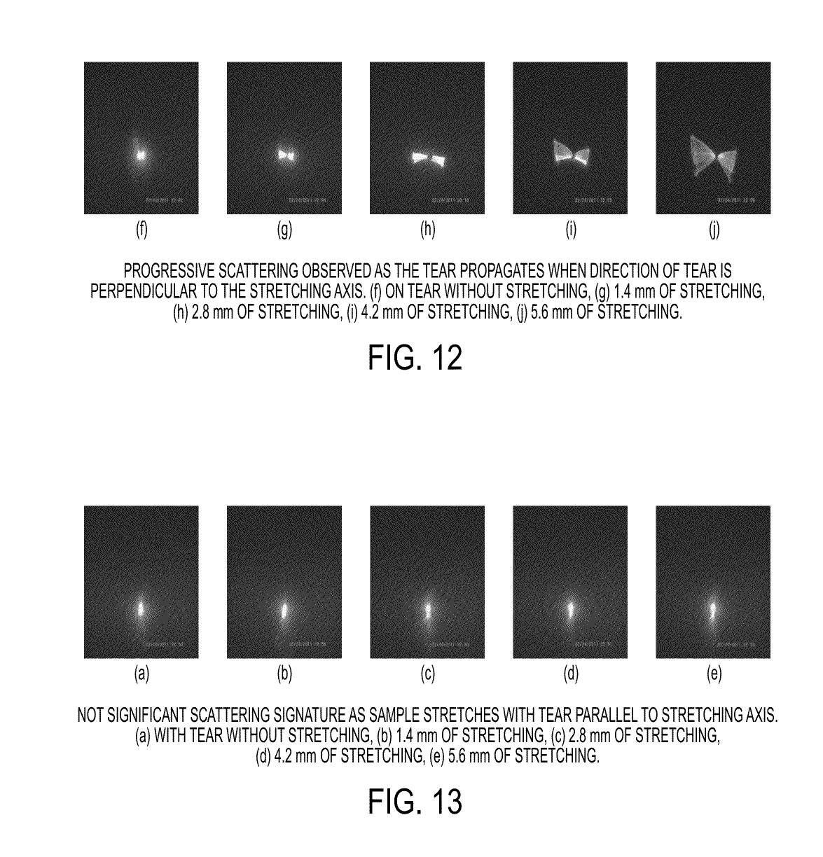

FIGS. 11, 12 and 13 are a series of photographs showing three samples of polymeric material subjected to the optical fatigue methods described herein.

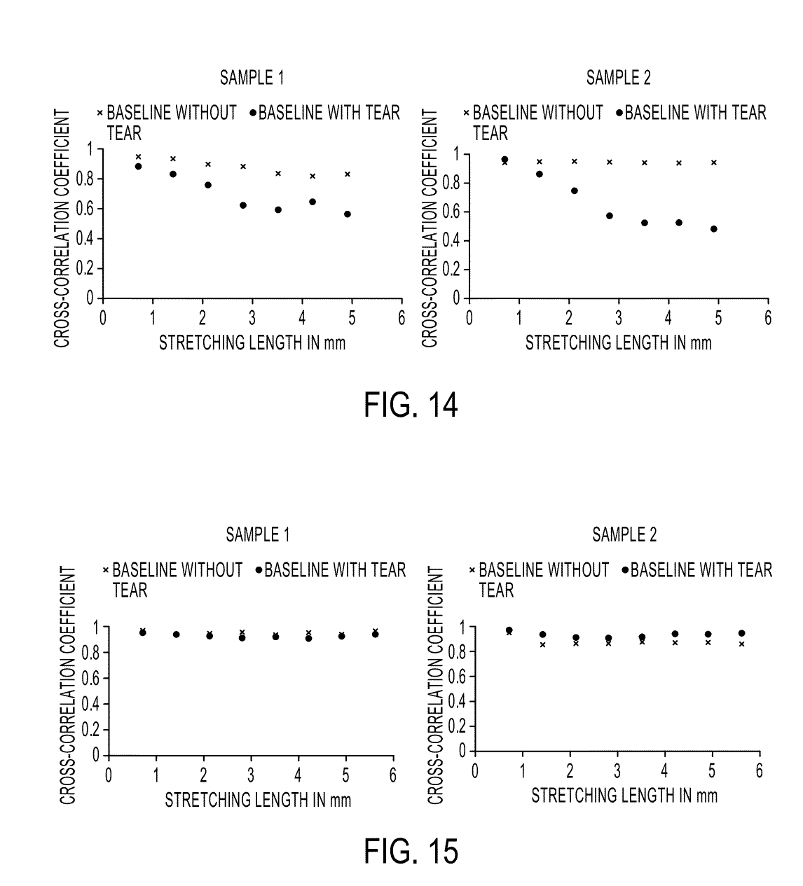

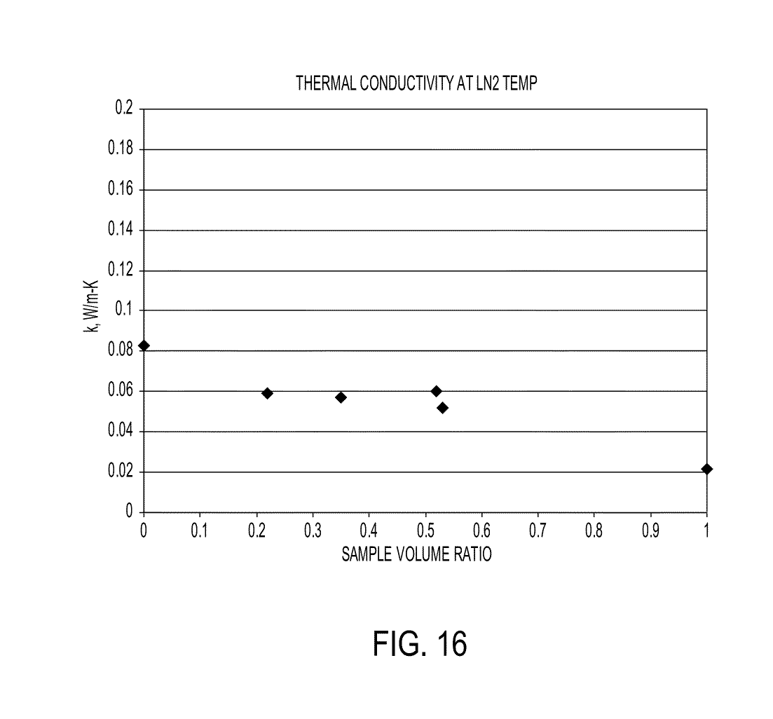

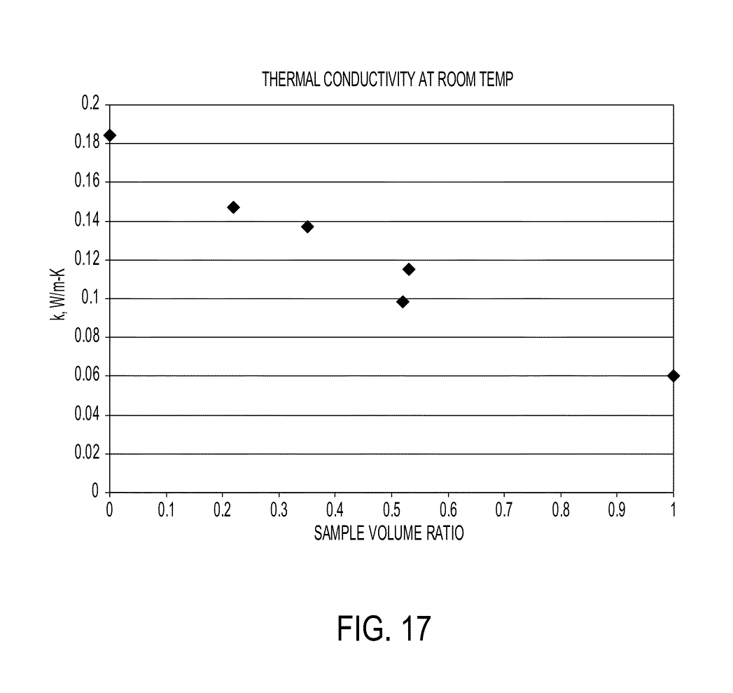

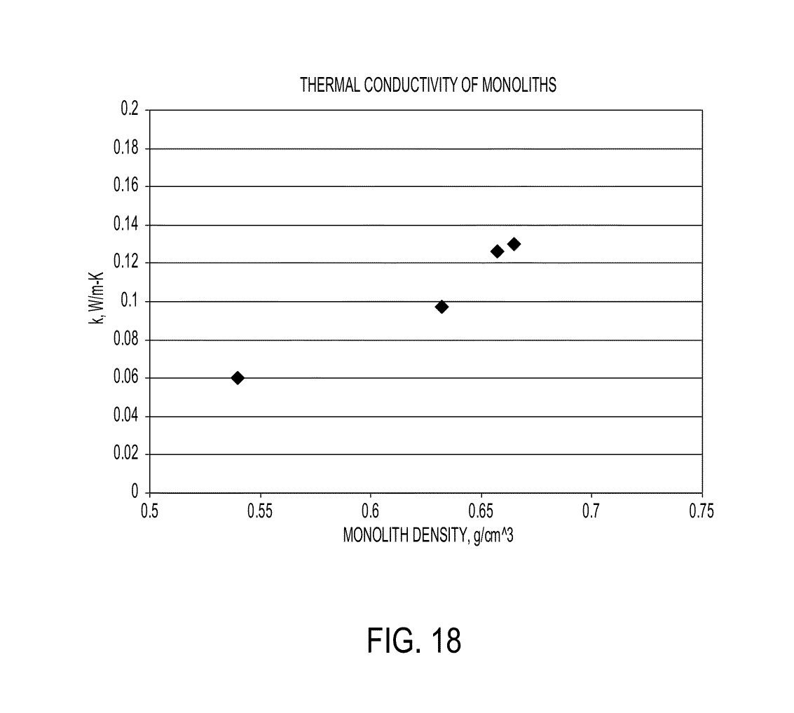

FIGS. 14 and 15 show the effects of stretching polymeric materials in the optical fatigue methods described herein.

FIG. 16 is a graph showing the effect of the volume ratio of the aerogel base material in insulating materials of the invention on the thermal conductivity of the insulator at room temperature.

FIG. 17 is a graph showing the effect of the volume ratio of the aerogel base material in insulating materials of the invention on the thermal conductivity of the insulator at liquid nitrogen temperatures.

FIG. 18 is a graph showing the effect of the aerogel density in insulating materials of the invention on the thermal conductivity of the insulator at room temperature.

### DETAILED DESCRIPTION OF THE INVENTION

The “insulating material” of the present invention provides advantages over traditional materials in that the aerogel based material described herein provides high thermal insulation while remaining chemically and electrically resistant, resilient, pliable and flexible against low temperatures. Furthermore, it is possible to reliably color-code these materials through adding pigments (such as oxide-based pigments), e.g., at the synthesis stage, so the materials may be tinted to allow for color-coding of insulation to allow for easy recognition by one of skill of the art any of a number of properties including quantity or thickness of aerogel, insulation capacity, or tensile strength.

### DEFINITIONS

As used herein, the terms “aerogel” and “aerogel base” describe a class of materials having a low density, open cell structures, large surface areas, and nanometer scale pore sizes. Aerogel materials can be provided at least in powder, granular, bead, and other suitable forms, and include inorganic, organic, and hybrid organic-inorganic compositions, or some combination of the above forms and/or compositions. In certain embodiments aerogel materials can be provided in the form of an aerogel monolith

The term “aerogel monolith” describes a unitary structure of any size, shape or denisty comprising a continuous aerogel.

As used herein the terms “aerogel geometric body” and “discrete aerogel geometic body” refer to a three-dimensional unit of aerogel material which has a discrete shape and size. In certain embodiments, the aerogel geometric bodies may be discrete aerogel monoliths. Aerogel geometric bodies can be in the form of plates, discs, coins, beads, grains, rings, fibers, cubes, blocks, rods, cones, tubes, toroids, triangular prisms, rectangular prisms, pyramids, spheres, microspheres or any other shape which may be useful for a particular application.

The term “compound polymer-aerogel material” refers to a material comprising a polymer and an aerogel base material which have been crosslinked, cured together, or otherwise mixed together to form a material in which neither component can be separated without destruction of the material.

As used herein, the terms “porous material” and “porous base” describe a class of materials having a naturally or manually engineered porous structure that allows the flow of fluids and/or gasses across the material. The pores of the porous material may be continuous or not. Any material with naturally forming or artificially created pores. Porous materials can be provided at least in powder, granular, bead, and other suitable forms, and include inorganic, organic, and hybrid organic-inorganic compositions, or some combination of the above forms and/or compositions.

As used herein the terms “porous geometric body” and “discrete porous geometic body” refer to a three-dimensional unit of aerogel material which has a discrete shape and size. Porous geometric bodies can be in the form of plates, discs, coins, beads, grains, rings, fibers, cubes, blocks, rods, cones, tubes, toroids, triangular prisms, rectangular prisms, pyramids, spheres or any other shape which may be useful for a particular application.

The term “compound polymer-porous material” refers to a material comprising a polymer and an porous base material which have been crosslinked, cured together, or otherwise mixed together to form a material in which neither component can be separated without destruction of the material.

The term “impregnated” or “impregnating” refers to the process by which aerogel geometric bodies or porous geometric bodies are inserted into or immobilized within the polymer material or formed into a compound polymer-aerogel material. The impregnation may be done such that the geometric bodies are distributed or arranged in any way as may be useful for a particular application. The impregnation may be done so that the geometric bodies are evenly distributed and spaced within the polymer material. The impregnation may also be done so that the geometric bodies are distributed into specific areas of a polymer material as may be useful for a particular arrangement.

The term “high temperature” refers to temperature above 32° C. including, but not limited to temperatures greater than 100° C., greater than 150° C., or greater than 200° C.

The term “low temperature” refers to temperatures below 32° C. including but not limited to temperatures less than 0° C., less than −50° C., or less than −100° C.

The term “pre-fabricated article” refers to any article to which an insulating material can be applied, either on the surface or in the interior of such to thereby provide the article with one or more layers of thermal insulation.

### Polymers Materials

The polymer materials of the present invention can be any polymeric material which is stable, chemically and electrically resistant, resilient, pliable or flexible in both low and high temperatures. The polymer materials of the present invention can also be any polymeric material which is cable of being impregnated or compounded with an aerogel base material.

In certain embodiments, the polymer materials of the instant invention are elastomeric polymers. Elastomeric polymers include, but are not limited to, unsaturated rubbers, saturated rubbers, or thermoplastic rubber.

In some embodiments, the elastomeric polymer of the invention is an unsaturated or saturated polymer. Such polymers include, but are not limited to, cis-1,4-polyisoprene natural rubber, trans-1,4-polyisoprene gutta-percha, synthetic polyisoprene, polybutadiene, chloroprene rubber (cr), polychloroprene, neoprene, baypren, butyl rubber, halogenated butyl rubber, styrene-butadiene rubber, nitrile rubber, hydrogenated nitrile rubber, therban, zetpol, epm rubber, epdm rubber, epichlorohydrin rubber, polyacrylic rubber, silicone rubber, fluorosilicone rubber, a fluoroelastomer, a perfluoroelastomer, a polyether block amide, chlorosulfonated polyethylene, or ethylene-vinyl acetate.

In some embodiments, the elastomeric polymer of the invention is a thermoplastic polymer. Such thermopastic polymers include, but are not limited to, polycarbonate; polyamides (nylon), e.g., Mitsubishi MXD6, or ZYTEL (alternatively referred to as “PA66”); polyolefins, e.g., HDPE, PP, Mitsui TPX or PMP, VERSIFY, or CRYSTALOR; polyacetals, e.g. DELRIN; polyesters, e.g., BIOPOL, DACRON, or polycarbonates, e.g., LEXAN; poly(ether sulfones), e.g., UDEL; conducting polymers, e.g., ZYPAN or Ligno-PANI; acrylic polymers, e.g., LUCITE; polyanilines, polyimides such as TORLON or ULTEM; polyketones, such as KADEL or VICTREX; polysulfides, e.g., RYTON; vinyl polymers, e.g., XAREC or polystyrene; polyethers; polysilicones, polyheterocyclics; polyethylenes; polyureas; polyurethanes; liquid crystal polymers, e.g. VECTRA; and derivatives thereof. Other similar polymers can likewise be used.

In still other embodiments, the elastomeric polymer is not a thermplastic polymer.

In particular embodiments, the polymer material comprises a polyolefin, a polyester, a polyamide, a polyether, a polyurethane, an acrylic polymer, a polyimide, a polyurea, a polypyrrole, a polythiophene, a polyanaline, an acrylic polymer, a vinyl polymer, a polysiloxane, a polysulfide, or copolymers or mixtures thereof.

In a particular embodiment, the elastomeric polymer is a liquid silicone rubber. In still other embodiments liquid silicone rubber is RTV.

Aerogels

The aerogel base of the present invention can be any polymeric material comprising an open interconnected macroporous system with mesoporous walls. In general, aerogel bases of the present invention are silica aerogels which are generally low-density mesoporous solids formed as wet silica gels and dried through supercritical fluid extraction of the pore-filling gelation solvent. The aerogels can also be formed by replacing the supercritical drying stage with oven drying, or, controlled atmospheric drying.

In certain embodiments, the aerogels of the present invention may be a silica aerogel, a carbon aerogel, an alumina aerogel, a chalcogel, or an organic aerogel, or combinations thereof. In still other embodiments, the aerogel of the present invention may be a metal oxide aerogel. In yet other embodiments, the aerogel may be an aerogel of silica, titania, zirconia, alumina, hafnia, yttria, ceria, carbides, nitrides and any combination thereof.

In certain embodiments, the aerogels may be present as discrete aerogel monoliths. In such monoliths, the aerogels are formed of a singluar aerogel unit of the desired shape, size and density.

In still other embodiments, the aerogel may be a metal-aerogel nanocomposite. Metal-aerogel nanocomposites can be prepared by impregnating the hydrogel with solution containing ions of the suitable noble or transition metals. The impregnated hydrogel is then, in one embodiment, irradiated with gamma rays, leading to precipitation of nanoparticles of the metal. Such composites can be used as eg. catalysts, sensors, electromagnetic shielding, and in waste disposal. A prospective use of platinum-on-carbon catalysts is in fuel cells.

In certain embodiments, the aerogels of the present invention are hydrophobic aerogels including, but not limited to polymer crosslinked aerogels (x-aerogels). In still other embodiments, the hydrophobic aerogel is a poly-urea x-aerogel.

The aerogel base of the present invention may be produced by any method, some of which are known in the art. In particular, x-aerogels may be produced by known procedures, such as those found in Leventis, N. et al. Nano Lett. 2002, 2, 957-960; Meador, M. A. B. et al. Chem. Mater. 2007, 19, 2247-2260; and Leventis, N. Acc. Chem. Res. 2007, http://dx.doi.org/10.1021/ar600033s.

The aerogel base of the present invention can be of any density. In particular embodiments, the aerogel base of the present invention is from about 0.25 to about 1.50 g/cm³. In other embodiments, the aerogel base of the present invention is from about 0.3 to about 1.0 g/cm³. In still other embodiments the aerogel base of the present invention is from about 0.50 to about 0.70 g/cm³.

Porous Materials

The porous base of the present invention can be any biocompatible organic, inorganic, metallic, polymeric or composite porous material. In certain embodiments, the porous materials have a naturally or manually engineered porous structure or scaffold that allows the flow of fluids and/or gasses across the material. The pores of the porous material may be continuous or not. The porosity should be sufficient to facilitate tissue ingrowth when deployed within an intracorporeal cavity. Porosity can have a pore size ranging from about 10 nanometers to about 600 micrometers. The surface pores are typically about 20 nanometers to about 80 micrometers and the interior pores are about 20 nanometers to about 200 micrometers. In certain embodiments, Porosity can have a pore size ranging from about 10 nanometers to about 10000 nanometers. Implant porosity is generally formed in the implant prior to deployment within the body cavity in order to control the size and shape of the implant.

In certain embodiments, the porous base materials can be a plastic material including, but not limited to: PET, polethylene terephthalate; PBT, polybutylene terephthalate; PSU, polysulfone; PES, polyethersulfone; PAS, polyarylsulfone; PPS, polyphenylene sulfide; PC, polycarbonate; PA, polyamide; PAI, polyamide-imide; TPI, thermoplastic polyimide; PAEK, polyaryletherketone; PEEK, polyetheretherketone; PAEN, polyarylethernitrile; PE, polyethylene; PP, polypropylene; and PEK, polyetherketone.

In other embodiments, the porous material may be selected from organic materials. Such materials can include, for example, biocompatible polymers, oligomers, or pre-polymerized forms as well as polymer composites. The polymers used may be thermosets, thermoplastics, synthetic rubbers, extrudable polymers, injection molding polymers, moldable polymers, spinnable, weavable and knittable polymers, oligomers or pre-polymerizes forms and the like or mixtures thereof.

In other embodiments, the porous materials may be biodegradable organic materials, including, but not limited to, chitosan, alginate, collagen, albumin, gelatine, hyaluronic acid, starch, cellulose (methylcellulose, hydroxypropylcellulose, hydroxypropylmethylcellulose, carboxymethylcellulose-phtalate); furthermore casein, dextrane, polysaccharide, fibrinogen, poly(D,L lactide), poly(D,L-lactide-Co-glycolide), poly(glycolide), poly/hydroxybutylate), poly(alkylcarbonate), poly(orthoester), polyester, poly(hydroxyvaleric acid), polydioxanone, poly(ethylene, terephtalate), poly(maleic acid), poly(tartaric acid), polyanhydride, polyphosphohazene, poly(amino acids), poly(L-lactic acid), polycaprolactone, poly(lactide-co-glycolide), poly(hydroxybutyrate), poly (hydroxybutyrate-co-valerate), polydioxanone, polyorthoester, polyanhydride, poly(glycolic acid), poly(D,L-lactic acid), poly(glycolic acid-co-trimethylene carbonate), polyphosphoester, polyphosphoester urethane, poly(amino acids), cyanoacrylates, poly(trimethylene carbonate), poly(iminocarbonate), copoly(ether-esters), polyalkylene oxalates, and polyphosphazenes, and all of the copolymers and any mixtures thereof. In certain embodiments, the porous base material is chitosan or collagen.

In certain other embodiments, the porous base material can be a porous ceramic, glass, or metal material, including, but not limited to, metals and metal alloys selected from main group metals of the periodic system, transition metals, such as copper, gold and silver, titanium, zirconium, hafnium, vanadium, niobium, tantalum, chromium, molybdenum, tungsten, manganese, rhenium, iron, cobalt, nickel, ruthenium, rhodium, palladium, osmium, iridium or platinum, or from rare earth metals. The material may also be selected from any suitable metal or metal oxide or from shape memory alloys any mixture thereof to provide the structural body of the implant. In certain embodiments the material is selected from the group of zero-valent metals, metal oxides, metal carbides, metal nitrides, metal oxynitrides, metal carbonitrides, metal oxycarbides, metal oxynitrides, metal oxycarbonitrides and the like, and any mixtures thereof. The metals or metal oxides or alloys used may be magnetic. Examples can include—without excluding others—iron, cobalt, nickel, manganese and mixtures thereof, for example iron, platinum mixtures or alloys, or for example, magnetic metal oxides like iron oxide and ferrite. In certain embodiments, the materials may be semi-conducting materials or alloys, for example semi-conductors from Groups II to VI, Groups III to V, and Group IV. Suitable Group II to VI semi-conductors are, for example, MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, HgTe, or mixtures thereof. Examples for suitable Group III to V semi-conductors are GaAs, GaN, GaP, GaSb, InGaAs, InP, InN, InSb, InAs, AIAs, AlP, AlSb, AlS and mixtures thereof. Examples for Group 1V semi-conductors are germanium, lead and silicon. The semi-conductors may also comprise mixtures of semi-conductors from more than one group and all the groups mentioned above are included.

In still other embodiments, the porous material can include at least one of stainless steel, tantalum, titanium, nitinol, gold, platinum, inconel, iridium, silver, tungsten, or another biocompatible metal, or alloys of any of these; carbon or carbon fiber; cellulose acetate, cellulose nitrate, silicone, polyethylene teraphthalate, polyurethane, polyamide, polyester, polyorthoester, polyanhydride, polyether sulfone, polycarbonate, polypropylene, high molecular weight polyethylene, polytetrafluoroethylene, or another biocompatible polymeric material, or mixtures or copolymers of these; polylactic acid, polyglycolic acid or copolymers thereof, a polyanhydride, polycaprolactone, polyhydroxybutyrate valerate or another biodegradable polymer, or mixtures or copolymers of these; a protein, an extracellular matrix component, collagen, fibrin or another biologic agent; or a suitable mixture of any of these.

Physical Parameters

The aerogel or porous base of the present invention may be formed into any size and shape desirable. In particular, the aerogel geometric bodies have a thickness ranging from 1 μM to about 60 cM. In other embodiments, the aerogel base has a thickness ranging from 10 μM to about 20 cM. In still other embodiments, the aerogel base has a thickness ranging from 100 μM to about 10 cM. In particular embodiments the thickness of the aerogel base is from 1 μM to 100 μM. In other embodiments, the thickness of the aerogel base is from 1 mM to about 5 mM. In certain embodiments, the aerogel base can be formed into a tube or series of interconnecting tubes.

In still other embodiments, the weight ratio of aerogel or aerogel geometric bodies to the polymeric material in the insulating material is preferably greater than 15:100. In particular embodiments, it is greater than 20:100, greater than 25:100, greater than 30:100, greater than 35:100, greater than 45:100, greater than 50:100, greater than 75:100, greater than 100:100, greater than 150:100, or greater than 200:100.

In particular embodiments, the weight ratio of the aerogel or aerogel geometric bodies to polymer material in the insulating material is greater than 1:15, greater than 1:10, greater than 1:5, greater than 1:2, greater than 1:1, greater than 2:1, greater than 5:1, greater than 10:1, or greater than 15:1.

In certain embodiments, when the polymeric material is a thermoplastic polymer, the ratio of aerogel or aerogel geometric bodies to the polymeric material is greater than 20:100.

In other embodiments, the aerogel or porous base of the present invention may be present in the insulating material in any volume ratio (percent aerogel by volume in the total insulated material) to provide the desired level of insulation. In certain embodiments, the aerogel or porous base of the present invention has a volume ratio from about 1% to about 99% of the total insulating material. In other embodiments, the aerogel or porous base of the present invention has a volume ratio from about 20% to about 80% of the total insulating material. In still other embodiments, the aerogel or porous base of the present invention has a volume ratio from about 35% to about 60% of the total insulating material.

In certain embodiments, the insulating material of the instant invention is opaque, transparent or translucent. In particular embodiments, the insulating material of the instant invention is transparent or translucent.

Dyes and Tinting

In certain embodiments, the aerogel base may be tinted using the methods described herein. Such tinting may be of any color desired for the particular application.

In certain embodiments, the material of the invention is pigmented or tinted such that the material can be color coded. In certain embodiments, material is color coded to identify the relative quantity of aerogel impregnated. In certain other embodiments, the aerogel base material is color coded to identify the thickness of the aerogel impregnated. In still other embodiments, the aerogel base material is color coded to identify the insulating capacity or the tensile strength of the material as a whole.

In some embodiments, the insulating material of the invention is pigmented, tinted or doped with metal oxide pigments, mixed metal oxide pigments, azurite pigments, red earth pigments, yellow earth pigments, metal complex dyes, carbon black, synthetic iron oxide pigments, ultramarine pigments or other inorganic pigments. In other embodiments, the insulating material of the invention is pigmented, tinted or doped non-metal based pigments or organic pigments, including but not limited to vegetable dyes, acid dyes, basic dyes, azoic Dyes, and sulphur Dyes.

Exemplary pigments include, but are not limited to, Chromium oxide (green), iron-oxide (red), cobalt oxide (blue), grapheme, carbon, titanium dioxide, or iron oxide. In some embodiments, a particular the porous or the aerogel base may be tinted using more than one color when more than one type of cell is to be adhered. Similarly, the porous or the aerogel may be tinted entirely or may be tinted only along the directional growth path for the particular cell growth.

Methods of Use/Articles of Use

In certain embodiments, the insulating material of the invention can be used provide insulation to a variety of apparatuses which require such insulation. In certain embodiments, the insulating materials of the invention can be used to provide insulation against very low temperatures. In other embodiments, the insulating materials of the invention can be used to provide insulation against high temperatures. In still other embodiments, the insulating material of the invention can be used to provide insulation against both low temperatures and high temperatures.

The insulating materials are useful in food service, racing, aerospace, textile, electronic, and military industries. More particularly, they can be used in food packaging and other storage containers, tanks, pipes, valves, components, structural supports, and garments, as well as other similar mechanical devices and cold or hot fluid process systems.

In one embodiment, the articles are seals or gaskets for fluid process systems.

In one embodiment, the articles are pipes, tubes, or containers for transporting or containing fluids or gases.

In a specific embodiment, the insulating material of the invention can be used to prepare a cryogenic tank. In such applications, one or more layer of the insulating material of the invention can be applied to the outside of a cryogenic tank. In such instances, the seams of the layers can be sealed by curing an additional amount of the silicone polymer material In other instances, the insulating material of the invention can be cured directly onto the tank or apparatus to be insulated.

In some embodiments, the insulating material itself can be formed into an article. In still other embodiments, the insulating material can be used to coat, enrobe, encapsulate or otherwise surround a pre-fabricated article with the insulating material. In certain embodiments the pre-fabricated article is made of metal, plastic, silicone, polymer, elastomer, wood, glass, porcelain, bone, stone, or concrete or a combination thereof. In certain other embodiments the pre-fabricated article is not made of metal.

In some embodiments, the article of the invention and/or the pre-fabricated article is a tank, including a cryogenic tank, a cup, a bowl, a pot, an insulated window, home insulation, or an insulated fabric material.

### EXAMPLES

The present invention may be further illustrated by the following non-limiting examples. All reagents were used as received unless otherwise noted. Those skilled in the art will recognize that equivalents of the following supplies and suppliers exist, and as such the suppliers listed below are not to be construed as limiting.

### Example 1

### Preparation of Aerogels

### Materials and Methods

Preparation of Pigment-Doped Aerogels:

Two solutions, the first containing 3.85 mL tetramethoxysilane (TMOS), 3-aminopropylsilane and methanol (4.5 mL) and the second one containing methanol (4.5 mL), water (1.5 mL) and a suspension of the metal oxide pigment (4% weight) were cooled in a mixture of dry-ice acetone. The cold solutions were shaken vigorously and were mixed while cold. The resulting sol was immediately poured into molds and gelled within 60 sec while still cold. The gels were aged for 3 hrs then washed once with methanol (once) and four times with acetonitrile using 4-5 times the volume of the gel for each wash. Subsequently, gels were transferred in an isocyanate bath containing 33 g of Desmodur N3200 (Bayer) in 94 mL of acetonitrile. The volume of the bath was again 4-5 times the volume of each gel. After 24 hrs, the gels were transferred in fresh acetonitrile and they were heated at 70° C. for 72 hrs. At the end of the period, the gels were washed another four times with fresh acetonitrile (24 hrs each time) and they were dried supercritically using liquid CO₂. Chromium oxide (green), iron-oxide (red), and cobalt oxide (blue) were the pigments of choice for color-coding the aerogels. All pigments were tested for stability under thermal, vacuum, and UV exposure conditions.

### Example 2

### Preparation of Aerogel Substrates

Making of Aerogel Substrates:

Two solutions, the first containing 3.85 mL tetramethoxysilane (TMOS), 3-aminopropylsilane and methanol (4.5 mL) and the second one containing methanol (4.5 mL), water (1.5 mL) and a suspension of the metal oxide pigment (4% weight) were cooled in a mixture of dry-ice acetone. The cold solution was shaken vigorously and was mixed while cold. The resulting solution was immediately poured into molds and gelled within 60 seconds while still cold.

The gels were aged for 3 hours and subsequently washed once with methanol and four times with acetonitrile using 4-5 times the volume of the gel for each wash. Subsequently, gels were transferred in an isocyanate bath containing 33 g of Desmodur N3200 (Bayer) in 94 mL of acetonitrile. The volume of the bath was again 4-5 times the volume of each gel.

After 24 hours, the gels were transferred in fresh acetonitrile and they were heated at 70° C. for 72 hours. At the end of the period, the gels were washed another four times with fresh acetonitrile (24 hours each time) and they were dried using liquid CO₂, taken out at the end supercritically (M. Hobbs, R. S. Duran, N. Leventis, L. A. Capadona “Isocyanate-Crosslinked Metal Oxide-Doped Silica Aerogels in Chromatic Calibration Targets for Planetary Exploration,” PMSE Preprints 2006, 94, 569.)

### Example 3

### Preparation of Aerogel-Silicone Polymer Materials

Prototype Mold Design

Molds for the aerogel samples and building molds for curing the silicone polymer are prepared from teflon, stainless steel, aluminium, or ultra high molecular weight polyethylene (UHMWPE) using standard machine molding techniques. The molds are tested for tolerance to the chemicals used during the synthesis stage.

Synthesis

Aerogel:

Vanadium crosslinked and polyurea crosslinked silica aerogels are synthesized using one of two methods:

1) evaporative technique as described in reference [2]; and

2) critical point drying (CPD) in a liquid CO₂ environment.

The thermal insulation quality of the aerogels are measured and compared with Aspen Aerogel blankets reported values. A tensile (compression) tester monitors the mechanical properties of each synthesized batch.

Silicone Polymer:

Silicone polymer sheets are synthesized and layered with uniform thickness aerogel discs prior to curing. The exact layering arrangement, size of each disc, and distribution is optimized after data collected from the first synthesis and characterization runs.

In a specific example RTV-655 is used as the silicone polymer

### Example 4

### Preparation of Cross Linked Aerogel Monolth-Silicone Rubber Materials

Silicone rubber RTV-655 was used to embed a polyurea-crosslinked silica aerogel monoliths to prepare an insulating material of the invention by the method below:

1. a first batch of RTV-655 was mixed and outgassed;

2. outgassed RTV-655 was poured into a cleaned aluminum mold and outgassed again;

3. the mold was baked to cure in an oven at 90° C. for about 1 hour and cooled to form a molded RTV base;

4. a second batch of RTV-655 was mixed and outgassed;

5. the second batch of RTV-655 was poured into the mold with the molded RTV base;

6. a polyurea-crosslinked silica aerogel monolith was added to the uncured RTV-655 layer;

7. the RTV-655 layer was cured for about 12 hours at room temperature to form a crosslinked aerogel/RTV material within the mold;

8. a third batch of RTV-655 was mixed and outgassed;

9. the third batch of RTV-655 added to the mold with the crosslinked aerogel/RTV material to provide the desired volume ratio and outgassed;

10. the final insulating material was cured at room temperature until completely cured.

FIG. 2 shows a sample of the insulating material made by the method described above. Also shows are the aerogel monolith before embedding in the polymeric material and a sample of the cured RTV-655 without the aerogel monolith incorporated

FIG. 3 shows various samples prepared by adapting the method described above at various volume ratios of aerogel to insulating material (VR=32%, VR=52% VR=57% and VR=62%).

### Example 5

### Mechanical and Thermal Property Characterization of Aerogel-Silicone Polymer Materials

The mechanical and thermal properties of the assembly is compared to similarly cured Silicone polymer sheets without the embedded aerogel units. The R (insulative) value, conductivity value, and heat transfer rate are determined experimentally using standard laboratory equipment such as thermocouples and Keithley multimeters. These values are incorporated into an enhanced CFD model (as described in Example 7) to simulate the self-pressurization of LH₂ (Liquid Hydrogen) and LOX (Liquid Oxygen) in a cyrogenic tank.

Room Temperature Mechanical Tests:

Using a bench top tensile tester load-bearing cycle tests are performed on Silicone polymer only sheets and, aerogels embedded Silicone polymer strips. Specifically, formation of microcracks, tear, and propagation of tear are studied. SEM analysis during and after cycling tests is performed.

Low Temperature Mechanical Tests:

High Mach Environment Mechanical Tests:

Individual sections of the aerogel embedded RTV sheets are exposed to a high mach environment at a combustion driven wind tunnel.

### Example 6

### Preparation of Aerogel-Silicone Polymer Insulated Cryogenic Tank

A bench top tank of the order of 1 ft in height is molded and assembled using prepared crosslinked aerogel embedded insulating material sheets of the invention. Any “seams” present are sealed with more silicone polymer to guarantee continuity of chemical compound. The miniature tank is filled with liquid nitrogen initially and tested for leaks, and thermal stability.

The complete assembly is exposed to a high mach environment at a combustion driven wind tunnel. The complete assembly is also be subject to HV (high vacuum), SV (soft vacuum), and NV (no vacuum) pressure.

Specific measurements are taken for complete assembly:
variation of k-value with cold vacuum pressure;
measurements of Boil-off and k-values as a function of elapsed time; and
“debris” collision tolerance.

### Example 7

### CFD Modeling

Model Development and Verification

FLUENT will be enhanced to compute the internal energy required to implement the EOF approach. The enhanced model will numerically predict thermodynamic properties in each computational cell. The simulation results will provide temperature and pressure histories for the tank fill.

Model Validation

Verification and validation will occur to assess the fidelity of the enhanced FLUENT model. Previous development work cited has included similar test cases. The tasks below indicate how the current model will be verified and validated:

a. Execute a test case of pure bulk evaporation of refrigerant R-12. Compare evolution of evaporation process to that reported by Anghaie [29,30].

b. Execute normal gravity test cases to predict temperature and pressure profiles inside a tank containing liquid hydrogen and compare the simulation results to experimental data reported by Chato [9].

c. Execute microgravity test cases to predict temperature and pressure profiles inside a tank containing Freon 113 and compare the simulation results to reported by Hasan et al. [16-19]

Simulation Predictions

The enhanced FLUENT simulation will be used to compare and assess several proposed insulation technologies for controlling cryogen tank self-pressurization in low gravity: Measured conductivity, heat flux, and emissivity values for insulation technologies such as MLI, foam, fiberglass, aerogel beads, and perlite powder will be input into the simulation and self-pressurization will be assessed over time for both LOX and LH2. The thermal control capabilities of the proposed RTV encapsulated crosslinked aerogel tank will be compared to the alternative technologies as a function of aerogel thickness, surface area and the thickness of the RTV encapsulant.

### Example 8

### Mechanical Testing of Cross-Linked Silica Aerogel Impregnated-Silicone for Cryogenic Tank Applications

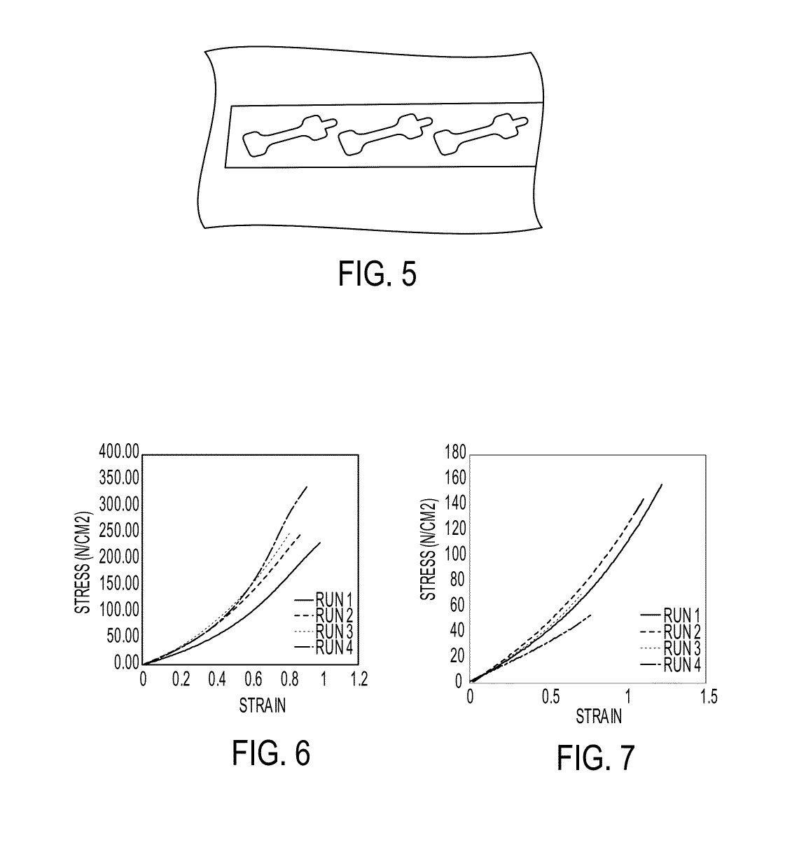

The experiment was performed using a table top tensile tester which was calibrated following manufacturer's instructions. Following ASTM standards, the load each sample experienced due to the test was measured in Newtons, and the travel was measured in millimeters. The samples were shaped using ASTM standards of a dog bone shape as seen in FIG. 5. The thickness of each sample was 1.5 mm, the length of the neck was 22 mm, and each neck had a width of 5 mm. Each sample was assembled by synthesizing RTV-655, out gassing the silicone in a vacuum chamber, and then adding an amount of aerogel powder to give the desired ratio of volume of aerogel to volume of the whole sample was then uniformly stirred into the material. The mixed material was out gassed for a second time. All tests were done at 19 degrees Celsius. Tensile tests were performed with the Mark 10 table top tensile tester. Spring loaded clamps were used for holding the material. The springs allowed for proper gripping during testing as the sample was thinned during stretching. Samples were inserted into clamps which were 20 mm apart from the closed position, and were aligned properly so no torque was exerted on the samples during testing. A twenty percent volume fraction was used in this experiment. The volume of RTV needed for this mixture was determined by knowing the desired percentage of aerogel to RTV, along with the known volume of aerogel available. The volume fraction, V_{f}, is defined as the volume of the aerogel to the total volume of the dogbone sample. The densities of the aerogel and RTV were used with the volume calculated earlier to find the appropriate mass of RTV-655 required to obtain the appropriate percentage. The tests were repeated in accordance with the ASTM standards.

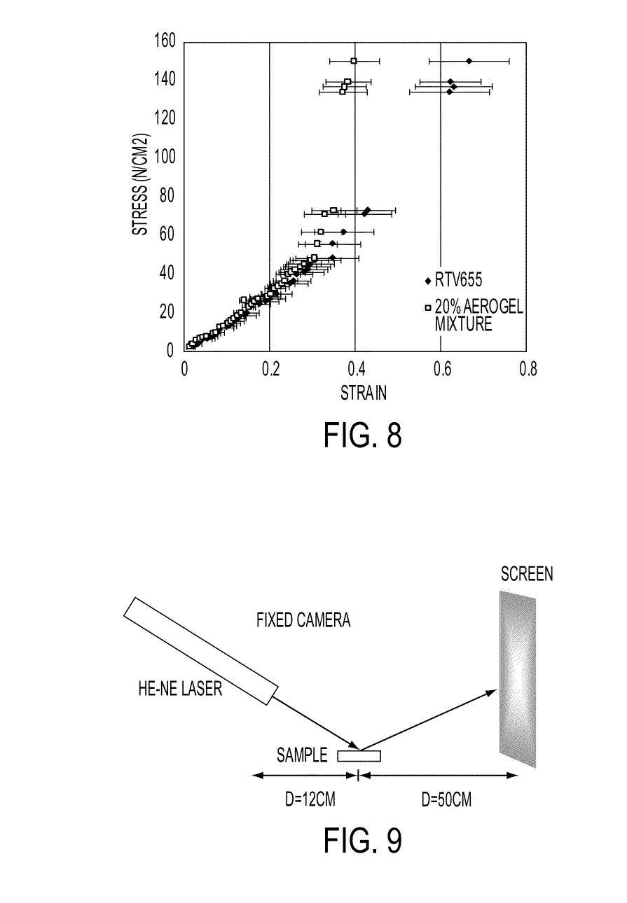

The objective of the investigation is compare the relationship between the applied load, in terms of stress, and the elongation, in terms of strain, for samples which contain only RTV-655 and samples with a volume fraction of aerogel, V_{f}=0.20. In addition, the tensile strengths of these samples are compared. For additional comparison, the manufacturer of RTV-655 has a published value of 594 N/cm², when the RTV-655 is cured for one hour at 100° C. Samples containing only RTV-655 are utilized as the benchmark for assessing whether any significant changes in the mechanical behavior can be ascertained by embedding aerogel particles into the RTV-655. FIG. 6. shows the tensile behavior of pure RTV-655 for four repeated tests. FIG. 7 shows the tensile mechanical behavior RTV-655 impregnated with 20% aerogel particles. It should be noted that FIGS. 6 and 7 are an accumulation of many data points, and not just one line connecting a few points. The mechanical responses to tensile loading for the four repeated tests for both the pure RTV-655 benchmark and the aerogel RTV-655 mixture (V_{f}=20%) show similar behavior, respectively. FIG. 8 compares the mean strain for the both the pure RTV-655 benchmark and the aerogel RTV-655 mixture (V_{f}=20%). The error bars are determined using the data from the 4 tests per sample and a 95% confidence interval. The strain behaviors of both samples are not statistically different under a tensile stress of less than 75 N/cm². However, as the stress increases closer to the tensile strengths of the materials, it is apparent in FIG. 8 that the pure RTV-655 undergoes more strain, approximately 0.2, than the aerogel RTV-655 mixture (V_{f}=20%). Since the error bars for the strains on both materials do not overlap when the tensile stress exceeds 75 N/cm², the differences observed are statistically significant. The tensile strength at failure was also measured for each of the test cases. Table 1 presents the mean tensile strength and experiment error for both the pure RTV-655 and the aerogel RTV-655 mixture (V_{f}=20%). As shown in the table, the difference in yield strain between materials is statistically insignificant. Thus, the differences in the elongation of both materials at the point immediately before failure are insignificant.

TABLE 1

| | Tensile Strength | |
|---|---|---|
| Sample | (N/cm²) | Yield Strain |
| RTV-655 | 269.167 ± .066 | .901 ± .883 |
| 20% Mixture | 107.161 ± .242 | .953 ± .934 |

### Example 9

### Optical Detection of Fatigue in Space Based Applications Utilizing Compound Cross-Linked Silica Aerogel-RTV 655

A non-destructive, non-contact optical technique utilizing lasers to detect fatigue in cross-linked silica aerogel-RTV compound material intended for space based cryogenic tank applications. The reflected interference pattern is captured using a CCD camera and the images are used to analyze the tears in the samples under investigation. Correlations are developed using the captured images to help predict material failure in a given sample of the aerogel-RTV compound material. For space based applications, a remote sensing, non destructive, optical technique is desirable and may be useful for detecting fatigue in a wide variety of materials intended for use in space.

The experimental setup used for the study is shown in FIG. 9. The setup is similar to the arrangement employed by Pernick et al (Optical method for fatigue crack detection B. J. Pernick and J. Kennedy Applied Optics/Vol. 19, No. 18/15 September 1980. A class IIIB, 50 mW He—Ne Laser, inclined at an angle of 35° above the horizontal plane, is focused onto the sample composed of pigmented Sylgard-184 and the reflected beam is observed on the screen. The samples were made according to the manufacturer recommended ratio of polymer to cross linker adding a cross-linker, a ratio of 10:1. Samples were made following the technique used by F. Sabri et al. (Spectroscopic evaluation of polyurea cross linked aerogels, as a substitute for RTV-based chromatic calibration targets for spacecraft F. Sabri, N. Leventis, J. Hoskins et al. Advance in Space Research 47 (2011) 419-427). The samples were out gassed in order to remove air bubbles and cured in a vacuum oven. The samples were removed from the curing molds, cleaned with acetone and isopropyl alcohol before mounting on a stretcher. Then the 4.57 cm×1.13 cm×0.47 cm rectangular samples were loaded in a 1-D rotating stretcher and were stretched clockwise where each rotation yields 0.7 mm of stretching. Images are captured by high definition Canon SD780 IS. Artificial tears were created in the polymer both perpendicular and parallel to the stretching axis. The 1-D stretching system was utilized for samples with tears and without tears for comparison. The distance between the light source and sample for this study was 12 cm and the screen was placed 50 cm away from the opposing side of the sample. The distance between the camera and the screen was 62 cm.

To analyze the captured images the method of cross-correlation coefficient was used. This is a standard method for estimating the degree to which two entities are correlated. In probability theory and statistics, the term cross-correlation is also sometimes used to refer to the covariance cov(X, Y) between two random vectors X and Y, in order to distinguish that concept from the “covariance” of a random vector X, which is understood to be the matrix of covariance's between the scalar components of X. This examines the potential of spatial image cross-correlation spectroscopy as a means for colocalization analysis and presents a comparison with standard co-localization methods that determines the suitability of the approaches under different circumstances and discusses potential limitations.

The statistical analyses performed on the acquired images are shown in the Tables 2 and 3. These images were taken for tears created in directions perpendicular to, and, parallel to the extension direction. Images were also captured for extension of polymers (tension) without any tears created at all. For samples that were stretched without any tears crated the cross correlation coefficient method shows very little difference as the sample is stretched.

For the case where the tear was created perpendicular to the stretching axis the correlation coefficient shows significant difference as the sample is stretched further.

In case of samples with tears created parallel to the stretching axis very little difference as the sample is stretched because stretching occurring in the direction of cut.

Also, from the FIGS. 11, 12 and 13 are shown below which respectively corresponds to no tear with stretching, stretching with perpendicular, and parallel cut in the stretching direction it is feasible to trace the propagation of fatigue when tear is perpendicular but hardly any significance difference is noticed for rest of the two conditions.

The graphs plotted in FIGS. 14 and 15 are shown below reveal the same phenomenon as a decreasing in cross-correlation coefficients are noticed for tear made perpendicular to the stretching axis whereas for rest of the other case remains almost same.

TABLE 2
List of cross-correlation coefficient when tear perpendicular with respect to stretching.

| | |
|---|---|
| Sample 1 | Sample 2 |

| | Test type | | | |
|---|---|---|---|---|
| | Cross-correlation | Cross-correlation | Cross-correlation | Cross-correlation |
| | between baseline & | between two | between baseline & | between two |
| | with stretch no tear | consecutive images | with stretch no tear | consecutive images |
| No stretching | Baseline | | Baseline | |
| no tear | | | | |
| No tear with | 0.951 | 0.951 | 0.943 | 0.943 |
| stretching of | 0.936 | 0.983 | 0.953 | 0.970 |
| 0.7 mm | 0.899 | 0.968 | 0.957 | 0.981 |
| | 0.885 | 0.984 | 0.953 | 0.972 |
| | 0.839 | 0.977 | 0.945 | 0.974 |
| | 0.822 | 0.973 | 0.939 | 0.981 |
| | 0.837 | 0.927 | 0.947 | 0.980 |
| | Test type | | | |
| | Cross-correlation | Cross-correlation | Cross-correlation | Cross-correlation |
| | between baseline & | between two | between baseline & | between two |
| | stretch with tear | consecutive images | stretch with tear | consecutive images |
| On tear without | Baseline | | Baseline | |
| stretching | | | | |
| On tear with | 0.887 | 0.887 | 0.964 | 0.964 |
| stretching | 0.837 | 0.862 | 0.855 | 0.852 |
| | 0.759 | 0.867 | 0.752 | 0.859 |
| | 0.627 | 0.828 | 0.572 | 0.841 |
| | 0.597 | 0.876 | 0.524 | 0.816 |
| | 0.650 | 0.818 | 0.526 | 0.849 |
| | 0.565 | 0.732 | 0.487 | 0.841 |

TABLE 3
List of cross-correlation coefficient when tear parallel with respect to stretching.

| | Sample 1 | | Sample 2 | |
|---|---|---|---|---|
| | Test type | | | |
| | Cross-correlation | Cross-correlation | Cross-correlation | Cross-correlation |
| | between baseline & | between two | between baseline & | between two |
| | with stretch no tear | consecutive images | with stretch no tear | consecutive images |
| No stretching | Baseline | | Baseline | |
| no tear | | | | |
| No tear with | 0.972 | 0.972 | 0.961 | 0.961 |
| stretching of | 0.946 | 0.961 | 0.857 | 0.916 |
| 0.7 mm | 0.954 | 0.981 | 0.871 | 0.978 |
| | 0.961 | 0.973 | 0.869 | 0.976 |
| | 0.940 | 0.977 | 0.877 | 0.983 |
| | 0.962 | 0.976 | 0.874 | 0.978 |
| | 0.941 | 0.969 | 0.876 | 0.985 |
| | 0.972 | 0.972 | 0.861 | 0.964 |
| | Test type | | | |
| | Cross-correlation | Cross-correlation | Cross-correlation | Cross-correlation |
| | between baseline & | between two | between baseline & | between two |
| | stretch with tear | consecutive images | stretch with tear | consecutive images |
| On tear without | Baseline | | Baseline | |
| stretching | | | | |
| On tear with | 0.955 | 0.955 | 0.974 | 0.974 |
| stretching | 0.945 | 0.955 | 0.945 | 0.950 |
| | 0.933 | 0.971 | 0.913 | 0.953 |
| | 0.917 | 0.969 | 0.915 | 0.966 |
| | 0.927 | 0.947 | 0.912 | 0.968 |
| | 0.915 | 0.961 | 0.943 | 0.962 |
| | 0.932 | 0.964 | 0.940 | 0.961 |
| | 0.943 | 0.924 | 0.954 | 0.924 |

The methods described herein are readily adapted to measurement of fatigue on the materials of the invention.

### Example 10

### Thermal Characterization of Cross-Linked Silica Aerogel-RTV for Cryogenic Tank Applications

To measure the conductivities of the cross-linked aerogel and RTV 655 compounds, a Therm Test TPS1500 was used. This instrument measures thermal conductivity of a sample based on the transient plane source technique previously described. A sample holder was designed for use at both high and low temperatures comprising top and bottom stainless steel plates that secure the samples, a sensor, and a stainless steel sheet metal casing around the sample. The casing prevents direct contact with the sensor when the holder is immersed in liquids. The outside casing was in direct contact with the bottom plate and allowed heat transfer by conduction to the samples. Stainless steel was chosen as the material of the sample holder due to a high strength, malleability and rust resistance. The sensor wires were attached to all thread, which was fed through virgin peek plastic inserts at the top of the sample holder. The plastic inserts sealed the container while providing electrical isolation over a wide temperature range. The shape and dimensions of the outside casing were constrained by the neck diameter of the cryostat and the internal volume of the oven.

Aerogel monoliths were synthesized for this study according to the method described by Leventis et al., 2002 N. Leventis, C. Sotiriou-Leventis, G. Zhang and A. M. M. Rawashdeh, “Nanoengineering Strong Silica Aerogels”. NanoLetters, 2 (2002), pp. 957-960. The synthesis process was initiated by combining 8.75 mL methanol, 3.85 mL tetramethyl orthosilicate, 1.5 mL D.I. water and 0.25 mL 3-aminopropysilane into a 100 mL glass beaker. The solution was mixed with a glass stir rod for approximately 20 seconds and poured into rectangular shaped molds. Once the solution turned into a gel, methanol was poured into the remaining volume of the molds to prevent the exposed surface from drying. The gels were removed from the molds after 3 hours and placed into a methanol bath. After 12 hours and each subsequent 12 hours, the sample bath was replaced with acetonitrile. After 3 days of flushing the solvent, the aerogel cylinders were crosslinked for 24 hours with a mixture of 94 mL acetonitrile and 33 g Desmodur N3200 (Bayer). The samples were again placed into an acetonitrile bath and baked at 70° C. for 72 hours. Once removed from the oven, the samples were placed into an acetone bath, which was replaced every 24 hours for 3 days to remove all of the excess crosslinking solution from the aerogel pores. The samples were then placed in a critical point dryer in acetone and flushed with liquid CO2 at 750 psi and 15° C. four times for three one-hour cycles. The chamber was heated to approximately 35° C. or until the CO2 reached a supercritical state. The resulting gaseous CO2 was slowly vented from the chamber for approximately one hour. A mean density of 0.583 g/cm3 was determined for the cross-linked silica aerogel cylinders used for this study. Monolith silica aerogel blocks were also synthesized using a double batch of chemicals with all process times also being doubled. Two different batches of aerogel blocks

Numerous samples with different volume ratios of cross-linked silica aerogel-RTV 655 were made for the investigation. The volume ratios of 0, 0.22, 0.35, 0.52, 0.53 and 1.0 were chosen for this study and measured out on a mass basis of the cylinder.

The RTV 655 was prepared according to the manufacturer guidelines, mixing a ratio 10:1 of the elastomer prepolymer (A) to the cross-linker (B). The components were thoroughly mixed with a glass spatula, placed in a vacuum oven and out gassed for approximately 10 minutes to eliminate air pockets. Aerogel monolith(s) was (were) added to the rectangular metallic mold. The outgassed RTV 655 was poured into the molds to a specified height encapsulating the monolith aerogel (s) positioned in the mold on a precisely measured layer of outgassed RTV 655. The molds were placed in a vacuum oven and outgassed for approximately 1 hour. Each sample was numbered according to the target volume of the aerogel embedded in the sample. The molds were cured in the oven for 60 minutes at 90° C. Once the molds returned to room temperature, the samples were removed and placed in a desiccator.

The mass of the RTV 655 in the sample was calculated by subtracting the mass of the cross-linked aerogel within the sample from the total mass of the sample. The mass of the aerogel was measured prior to being mixed with the RTV 655. The density of the cross-linked aerogel was calculated from the cylinders. The dimensions of the cylinders were measured with calipers and the mass was measured with a scale. Volume was calculated based on the dimensions and the density was found by dividing the mass by the volume. The volume of RTV and the volume of aerogel within each sample were calculated by dividing the density by the mass. The volume ratio of the sample was subsequently determined by dividing the aerogel volume by the total volume.

All aerogel-RTV 655 samples will subsequently be referred to by measured aerogel volume ratio and geometry.

A Therm Test TPS1500 thermal constants analyzer was used to measure thermal conductivity of the samples with an HP 500B-MT computer running on Windows 7 Pro software. O. H. Hendricks in Memphis, Tenn. manufactured the custom stainless steel sample holder. For cryogenic temperature measurements a Tayler-Wharton VHC-35 cryostat was used with liquid nitrogen purchased from Airgas. Elevated temperature measurements were performed with a Blue M Stabil-therm gravity oven/temperature controller. All temperature measurements were verified with an Oakton Temp300 thermocouple. A Polaron E3100 critical point dryer was used to dry the aerogel samples with the internal chamber temperature being controlled by a Polyscience LS5X recirculating chiller. A Precision Scientific Model 19 vacuum oven was used for out gassing and curing the samples. The RTV 655, aerogel and Desmodur were weighed with an Ohaus Pioneer PA64 scale. Dimensions were taken with a Cole-Palmer Traceable caliper.

A nickel foil sensor was used for thermal conductivity measurements with the Therm Test TPS1500. The sensor was calibrated for the TCR values at the measurement temperatures with stainless steel 304 and Owens-Corning Foamular XPS 150 polystyrene foam. The samples were inserted above and below the sensor in the sample holder. The sample holder was then placed in a hot or cold source and allowed to reach steady state at the temperature of the source. Measurements were conducted with the TPS1500 according to ideal settings for power and measurement time for the material tested. Five measurements were performed at each temperature for the calibration samples with the sample being repositioned in the holder after each subsequent measurement to verify repeatability. The RTV and aerogel samples were placed in the sample holder above and below the sensor. Room temperature measurements were conducted with the sample holder being exposed to the ambient air, the sample holder was placed in an oven set to 70° C. for the elevated measurements and the low temperature measurements were conducted with the sample holder suspended in LN2. The ambient temperature of the room averaged 16° C. while the liquid nitrogen temperature was measured at −198.5° C. Each sample was measured five times at each temperature to assess error and uncertainty in the experiment.

Table 4 and FIGS. 16-19 outline the thermal conductivity of various samples produced herein at room temperature (300K) and at liquid nitrogen temperatures (LN2). The samples varies in volume ratios and aerogel denistity as indicated.

TABLE 4

| Sample | Sample | Aerogel | | |
|---|---|---|---|---|
| Name | VR | Density | k, LN2 | k, Room |
| RTV 655 | 0 | — | 0.083 | 0.1843 |
| VR22 | 0.22 | 0.652 | 0.059 | 0.147 |
| VR35 | 0.35 | 0.617 | 0.057 | 0.137 |
| VR52 | 0.52 | 0.54 | 0.06 | 0.0982 |
| VR53 | 0.53 | 0.632 | 0.052 | 0.115 |
| Monolith 1 | 1 | 0.665 | — | 0.13 |
| Monolith 2 | 1 | 0.54 | 0.021 | 0.06 |

*The densities range from 0.54 to 0.7

By increasing the ratio of aerogel to base encapsulating polymer the thermal insulation behavior of the compound material increases both at low temperatures and at room temperature. This trend is expected to continue even at temperatures greater than room temperature. The overall insulating behavior is expected to increase as the density of the aerogel is decreased. The RTV 655 may be replaced with any other elastomeric material and the insulating trend is expected to follow.

### EQUIVALENTS AND INCORPORATION BY REFERENCE

Those skilled in the art will recognize, or be able to ascertain using no more than routine experimentation, many equivalents to the specific embodiments of the invention described herein. Such equivalents are intended to be encompassed by the following claims.

All references cited herein, whether in print, electronic, computer readable storage media or other form, are expressly incorporated by reference in their entirety and may be employed in the practice of the invention, including but not limited to, abstracts, articles, journals, publications, texts, treatises, technical data sheets, manufacturer's instructions, descriptions, product specifications, product sheets, internet web sites, databases, patents, patent applications, and patent publications.

### REFERENCES

[1] Lawrence W. Hrubesh, Richard W. Pekala “Thermal properties of organic and inorganic aerogels” JMR Vol. 9 issue 3, pp. 731-738
[2] http://ntrs.nasa.gov/archive/nasa/casi.ntrs.nasa.gov/20000103878_{—}2000150661.pdf
[3] J E Fesmire et al “Aerogel beads as cryogenic thermal insulation system” AIP Conf. Proc. May 10, 2002, Vol. 613, pp. 1541-1548
[4] Kyung Wha Oh et al, “Ultra-porous flexible PET/Aerogel blanket for sound absorption and thermal insulation” Journal of Fibers and Polymers, Vol. 10 pp. 731-737, Number 5 (2009)
[5] N. Leventis, “Polymer nano-encapsulation of templated mesoporous silica monoliths with improved mechanical properties” Journal of Non-Crystalline Solids, Vol. 354, pp. 632-644, 2008
[6] N. Leventis, et al “Polymer nanoencapsulated mesoporous vanadia with unusual ductility at cryogenic temperatures”
[7] Anghaie, S, and Ding, Z., “Modeling of Bulk Evaporation and Condensation,” NASA CR 198392, 1996.
[8] FLUENT Inc.: FLUENT 6.3 User's Guide, Lebanon, N.H., 2008.
[9] http://spaceflightsystems.grc.nasa.gov/Advanced/ISSResearch/MSG/ZBOT/
[10] Panzarella, C. H. and Kassemi, M., “On the Validity of Purely Thermodynamic Description of Two-Phase Cryogenic Storage Tank,” Journal of Fluid Mechanics, Vol 484, pp. 136-148, 2003.
[11] F. Sabri et al, Advances in Space Research Vol. 41, issue 1, pp 118-128 (2008), Thin film surface treatments for lowering dust adhesion on Mars Rover calibration targets
[12] Aydelott, J. C., Axial Jet Mixing of Ethanol In Cylindrical Containers During Weightlessness. NASA TP-1487 (1979).
[13] Aydelott, J. C., Modeling of Space Vehicle Propellant Mixing. NASA TP-2107 (1983)
[14] Poth, L. J., and Van Hook, J. R., “Control of the Thermodynamic State of Space-Stored Cryogens by Jet Mixing,” Journal of Spacecraft, Vol. 9, No. 5, pp. 332-336, May 1972.
[15] Chato, D. J. “Ground Testing on the Nonvented Fill Method of Orbital Propellant Transfer Results of Initial Test Series,” AIAA-91-2326, AIAA/SAE/ASME/ASEE 27th Joint Propulsion Conference, Sacramento, Calif., June 1991.
[16] Hasan, M. M, Lin, C. S, and Van Dresar, N. T., “Self-pressurization of a flightweight liquid hydrogen storage tank subjected to a low heat flux.” NASA TM 103804, 1991.
[17] Van Dresar, N. T., Lin, C. S, and Hasan, M. M., “Self-pressurization of a flightweight liquid hydrogen tank: Effects of fill level at low wall heat flux.” NASA TM 105411, 1992.
[18] Lin, C. S., Van Dresar, N. T. and Hasan, M. M., “Pressure control analysis of cryogenic storage systems.” J. Propulsion and Power, Vol. 20, No. 3, pp. 480-485, 2004.
[19] Lin, C. S., Hasan, M. M., and Van Dresar, N. T., “Experimental Investigation of Jet-Induced Mixing of a Large Liquid Hydrogen Storage Tank,” AIAA Paper 94-2079, July 1994.
[20] Hochstein, J. I., Ji, H-C., Aydelott, J. C., “Prediction of Self-Pressurization Rate of Cryogenic Propellant Tankage,” Journal of Propulsion and Power, Vol. 6, No. 1, pp. 11-17, 1990.
[21] Adelott, J. C., “Effect of Pressurization on Self-Pressurization of Spherical Liquid-Hydrogen Tankage,” NASA TN D-4286, 1967.
[22] Adelott, J. C., “Normal Gravity Self-Pressurization of 9 inch (23 cm) Diameter Spherical Liquid Hydrogen Tankage,” NASA TN D-4171, 1967.
[23] Sasmal, G. P., Hochstein, J. I. and Hardy, T. L., “Influence of Heat Transfer Rates on Pressurization of Liquid/Slush Hydrogen Propellant Tanks,” AIAA-93-0278, The 31st AIAA Aerospace Sciences Meeting, Reno, Nev., January 1993.
[24] Sasmal, G. P., Hochstein, J. I., Wendl, M. C. and Hardy, T. L., “Computational Modeling of the Pressurization Process in a NASP Vehicle Propellant Tank Simulation,” AIAA-91-2407, AIAA/SAE/ASME/ASEE 27th Joint Propulsion Conference, Sacramento, Calif., June 1991.
[25] Fite, L. W. “Characteristics if Nonvented Propellant Transfer,” Ph.D. Dissertation, Memphis State University, Memphis, Tenn., 1993.
[26] Panzarella, C. H. and Kassemi, M., “Self-Pressurization of Spherical Cryogenic Tanks in Space,” Journal of Spacecraft and Rockets, Vol 42, No. 2, pp. 299-308, 2005.
[27] Barsi, S., Kassemi, M., Panzarella, C. H., Alexander, LLD., “A Tank Self-Pressurization Experiment Using a Model Fluid in Normal Gravity,” AIAA-2005-1143, The 43rd AIAA Aerospace Sciences Meeting, Reno, Nev., January 2005.
[28] Barsi, S, and Kassemi, M., “A Numerical Study if Tank Pressure Control in Reduced Gravity,” AIAA-2006-0936, The 44th AIAA Aerospace Sciences Meeting, Reno, Nev., January 2006.
[29] Ding, Z. and Anghaie, S. “Numerical Modeling of Bulk Evaporation and Condensation with Constant Volume,” International Journal for Numerical Methods in Engineering, Vol 39, pp. 219-233 1996.
[30] Anghaie, S, and Ding, Z., “Modeling of Bulk Evaporation and Condensation,” NASA CR 198392, 1996.

What is claimed is:

1. An insulating material comprising a polymer material and an aerogel base material.

2. An insulating material comprising one or more layers wherein each layer comprises a polymer material and an aerogel base material.

3. The insulating material of claim 1, wherein the polymer material and the aerogel base material are compounded to form a single compound polymer-aerogel material

4. The insulating material of claim 1, wherein the aerogel base material is in the form of one or more discrete aerogel geometric bodies.

5. The insulating material of claim 4, wherein the aerogel base material is in the form of a plurality of discrete aerogel geometric bodies.

6. The insulating material of claim 5, wherein the polymer material is impregnated with the plurality of discrete aerogel geometric bodies.

7. The insulating material of claim 4, wherein the aerogel base material is in the form of one or more aerogel monoliths.

8. The insulating material of claim 4, wherein aerogel geometric bodies are in the form of plates, discs, coins, beads, grains, rings, fibers, or microspheres.

9. The insulating material of claim 4, wherein the aerogel geometric bodies have a thickness from about 1 μM to about 5 cM.

10. The insulating material of claim 5, wherein the aerogel geometric bodies and the polymer material have a total thickness from about 2 μM to about 10 cM.

11. The insulating material of claim 2, wherein the aerogel base material is tinted.

12. The insulating material of claim 1, wherein the polymer material is an elastomeric polymer.

13. The insulating material of claim 11, wherein the elastomeric polymer is an unsaturated rubber, a saturated rubber, or a thermoplastic rubber.

14. The insulating material of claim 12, wherein the elastomeric polymer is cis-1,4-polyisoprene natural rubber, trans-1,4-polyisoprene gutta-percha, synthetic polyisoprene, polybutadiene, chloroprene rubber (cr), polychloroprene, neoprene, baypren, butyl rubber, halogenated butyl rubber, styrene-butadiene rubber, nitrile rubber, hydrogenated nitrile rubber, therban, zetpol, epm rubber, epdm rubber, epichlorohydrin rubber, polyacrylic rubber, silicone rubber, fluorosilicone rubber, a fluoroelastomer, a perfluoroelastomer, a polyether block amide, chlorosulfonated polyethylene, or ethylene-vinyl acetate.

15. The insulating material of claim 13, wherein the elastomeric polymer is a silicone rubber.

16. The insulating material of claim 14, wherein the silicone rubber is RTV 655.

17. The insulating material of claim 1, wherein the aerogel base material is a silica aerogel, a carbon aerogel, an alumina aerogel, a chalcogel, or an organic aerogel.

18. The insulating material of claim 16, wherein the aerogel base material is a silica aerogel.

19. The insulating material of claim 1, wherein the polymer material is a silicone rubber and the aerogel base material is a silica aerogel.

20. A method for preparing an insulating material comprising a polymer material and an aerogel base material comprising
a. synthesizing an aerogel to form discrete aerogel geometric bodies; and
b. impregnating the polymer material prior to curing the polymer material with the aerogel geometric bodies; and
c. curing the polymer material to form the insulating material.

21. The method of claim 20, further comprising the step of determining an optimized arrangement of aerogel geometric bodies within the material prior to step b.

22. The method of claim 21, wherein the step of optimizing the arrangement of aerogel geometic bodies comprises determining the size and shape of the aerogel geometric bodies; determining the distribution pattern of the aerogel geometric bodies; or both.

23. The method of claim 20 wherein the aerogel geometric bodies are tinted to indicate layer thickness, layer thermal properties, layer dielectric properties, layer stiffness, or any combination thereof.

24. The method of claim 20, wherein the aerogel geometric bodies are tinted to indicate the insulating capacity of the material.

25. An article comprising an insulating material comprising a polymer material and an aerogel base material.

26. The article of claim 25, comprising one or more layers of an insulating material comprising a polymer material and an aerogel base material.

27. The article of claim 25, wherein the article is fabricated directly from the insulating material.

28. The article of claim 25, wherein the article is fabricated by coating, surrounding, encapsulating, or enrobing a pre-fabricated article with the insulating material.

29. The article of claim 28, wherein the pre-fabricated article is made of metal, plastic, silicone, polymer, elastomer, wood, glass, porcelain, bone, stone, or concrete.

30. The article of claim 25, which is capable of withstanding high temperature.

31. The article of claim 25, which is capable of withstanding low temperature.

32. The article of claim 25, which is a container for storing liquids.

33. The article of claim 25, which is a tank, a cup, a bowl, or a pot.

34. The article of claim 33, which is a cryogenic tank.

35. The article of claim 25, which is a cryostat.

36. The article of claim 25, which is a tube for transporting liquids.

37. The article of claim 25, which is an insulated window

38. The article of claim 25, which is home insulation.

39. The article of claim 25, which is an insulated fabric.
